(19) United States
(12) Patent Application Publication
(10) Pub. No.: US 2008/0204214 A1
(43) Pub. Date: Aug. 28, 2008

(54) Method for Controlling the Driving Operating of Motor Vehicles or Other Vehicles

(76) Inventors: Ulrich Reith, Schlier (DE); Mario Steinborn, Friedrichshafen (DE)

Correspondence Address: DAVIS BUJOLD & Daniels, P.L.L.C., 112 PLEASANT STREET, CONCORD, NH, 03301, US

(21) Appl. No.: 11/914,398

(22) PCT Filed: Apr. 18, 2006
(86) PCT No.: PCT/EP06/03514

§ 371 Date: Nov. 14, 2007

(30) Foreign Application Priority Data
May 20, 2005 (DE) 10 2005 023 246.9

(51) Int. Cl. B60Q 9/00

(52) U.S. Cl. 340/441

(57) ABSTRACT

A method for controlling the driving operation of motor vehicles in which specific driving conditions are detected by rotational sensors located at individual wheels and/or sub-assemblies in the power train, and are then evaluated in a control unit and converted into control commands for specific functions of the vehicle or into warning signals. ABS, ASC or EBS systems as well as automatic gearboxes are controlled in this manner. Rotational sensors detect the current rotational direction and additionally determine of the presence of a rotary motion. The rotation sensors permit numerous functions of the vehicle to be controlled in a simple manner and with the aid of various parameters obviate the need for the calculation of the rotational direction by way of the determination algorithms.

This application is a national stage completion of PCT/EP2006/003514 filed Apr. 18, 2006, which claims priority from German Application Serial No. 10 2005 023 246.9 filed May 20, 2005.

### FIELD OF THE INVENTION

The present invention relates to a method for controlling the driving operation of motor vehicles or other vehicles.

### BACKGROUND OF THE INVENTION

Methods for controlling the driving operation of motor vehicles are known, according to specific driving conditions which are detected by way of rotation sensors and evaluated in a control unit to control ABS, ASC or similar systems. Such rotation sensors provide the number of revolutions but not the corresponding rotational direction. If the rotational direction of the wheels or specific sub-assemblies of the power train is needed, it must be calculated by way of a determination algorithm based on different values in a relatively complex manner.

with this as a background, it is the object of the present invention to furnish a method for controlling the driving operation of motor vehicles or the like in which a complex determination algorithm for the calculation of the relevant number of revolutions can be ascertained.

### DETAILED DESCRIPTION OF THE INVENTION

Rotation sensors as such are known, but they have so far not been used for controlling the driving operation of motor vehicles. The present invention is based oh the knowledge that the use of rotation sensors not only make complex determination algorithms for the determination of the number of revolutions dispensable, but facilitate additional useful functions for the operation of a motor vehicle.

Thus, the present invention is based on a method for controlling the driving operation of motor vehicles or the like, for example wheel and/or track vehicles, according to which specific driving conditions are detected by way of rotation sensors that are assigned to individual wheels and/or sub-assemblies in the power train, are evaluated in a control unit and are converted into commands for specific functions of the vehicle or warning signals. In the present description, warning signals are understood to be general optic or acoustic signals as well as visual displays.

To realize the objective posed, this method additionally provides that rotation sensors are used as rotational direction sensors.

The present invention takes advantage of the further knowledge that the information about the current rotational direction also implies knowing whether there is rotary motion at all. The information “there is a rotary motion” is usually derived from the information on the number of revolutions. If the number of revolution equals zero, there is not rotary motion. If the number of revolutions is larger than zero (or larger than a defined threshold value), there is rotary motion. When using rotation sensors, this determination whether there is rotary motion or not can be replaced by the determination whether a rotary motion was detected or not.

When using rotation sensors according to the present invention, functions for which the knowledge whether there is rotation or not is relevant, as well as functions for which the knowledge of the current rotational direction is relevant, can be implemented.

At this point, some expressions used in the present description should be defined in more detail:
the expression “driving status” describes the motion of the vehicle up to standstill. It thus comprises the statuses “vehicle driving”, “vehicle stopped”, “vehicle driving forward” and “vehicle reversing”;
the expression “operating status” describes the motion of individual elements of the vehicle, comprising statuses such as “rotating wheel”, “non-rotating wheel”, “rotating sub-assembly”, etc.;
the expression “driving conditions” should be understood as the conditions specified by the driver according to the desired driving scheme, for example “accelerator activated”, “brake not activated”, “switched gear”, etc.;
the expression “stop condition” should be understood as the conditions specified by the driver according to the desired stop scheme, for example “brake activated”, “accelerator not activated”, etc.

According to a variation of the method, it is provided that the current rotational direction of at least one wheel and/or one sub-assembly in the power train is detected and evaluated for the determination of the operating statuses “rotating wheel or sub-assembly” or “non-rotating wheel or sub-assembly”, and/or of the driving statuses “vehicle driving” or “vehicle stopped”. As already explained in the present case, it is not the current rotational direction that is relevant, but the determination whether there is rotary motion or not.

Taking advantage of these properties, it is provided that on determination of the driving status “driving vehicle” and the simultaneous presence of the specified stop conditions (e.g., a certain brake pressure; accelerator not activated), the brake pressure is increased automatically until reaching the driving status “stopped vehicle” or the emission of a warning signal. This way, the vehicle is either stopped automatically or the driver is alerted so that he may take measures to secure the vehicle and prevent rolling when stopping is desired.

According to the present invention, the current rotational direction of various driven wheels is detected where, on determination of the operating status, “at least one rotating wheel and at least one non-rotating wheel” and the simultaneous presence of specified driving conditions (e.g., gear engaged; accelerator activated), a traction control system is activated, which redistributes the driving power of the spinning wheel to the fixed wheels in the usual way.

Similarly, the current rotational direction of various braked wheels can be detected where, on determination of the operating status, “at least one rotating wheel and at least one non-rotating wheel” and the simultaneous presence of specified driving conditions (e.g., gear engaged; brake pedal activated), an anti-locking system is activated, which reduces the brake pressure on the locking wheel in the usual way until it rotates again.

In a further embodiment of the present invention, the current rotational direction of both wheels of a pair of driven wheels is detected where, on determination of the operating status “at least one rotating wheel and at least one non-rotating wheel” and the simultaneous presence of specified driving conditions (e.g., gear engaged; accelerator activated), a differential lock is automatically connected.

A further advantageous use of the method of the present invention results for vehicles with a lifting axle and/or raising axle. In this case, it is provided that the current rotational direction of at least one wheel of the lifting axle is detected and that on determination of the operating status “rotating wheel of the lifting axle” as well as the presence of the driving condition “lifted lifting axle” and/or on determination of the operating status “non-rotating wheel of the lifting axle” and the driving status “driving vehicle” as well as the simultaneous presence of the driving condition “lowered lifting axle”, a warning signal is emitted.

This allows checking whether a lifting axle was actually lifted or lowered. If the sensors on the wheels of the lifting axle indicate that there is no rotary motion, the lifting axle can be assumed to be lifted while driving. The comparison with the nominal condition, that is, with the driving conditions specified by the driver, provides confirmation or information on any malfunction.

As already mentioned above, there are functions to which the current rotational direction of the wheels or sub-assemblies in the power train are relevant. This is provided by the employed rotation sensors according to the present invention.

Taking advantage of these properties, a further embodiment according to the present invention provides that the current rotational direction of at least one wheel or one sub-assembly in the power train is detected and evaluated for the determination of a driving status “vehicle driving forward” or “vehicle reversing” and/or “wheel or sub-assembly rotating forward” or “wheel or sub-assembly rotating backward”. This function allows checking whether the motion of the vehicle corresponds to the driving conditions specified by the driver or not. In the latter case, corresponding countermeasures can automatically be started or warning signals be generated.

Hence, a further refinement of the present invention provides that if there is a specific driving condition (for example, forward gear engaged and/or reverse gear engaged) and a driving status that opposes one of these driving statuses (for example, vehicle reversing and/or vehicle driving forward) is determined, a brake is automatically activated. If the driver of a vehicle selects a forward gear and wants to start the vehicle and a rotation sensor detects the vehicle is rolling backward, a brake that prevents this can be activated. On the contrary, if the vehicle starts rolling in the direction desired by the driver, an activated brake could be released. Rolling down a mountain would be possible this way.

In contrast to the function described above, a further embodiment of the present invention provides that on determination of a certain driving status (e.g., vehicle driving forward and/or vehicle driving backward) without the presence of a corresponding driving condition (e.g., forward gear engaged and/or reverse gear engaged), a brake is automatically activated. If a driver coasts his vehicle downhill, a brake could be activated that would stop the vehicle as soon as a rotation sensor detects that the vehicle is changing direction.

When rocking a vehicle free, it is important to detect when a vehicle's motion out of the hole starts rolling in the opposite direction and to react rapidly by switching to the opposite direction or actually contributing to it, According to an embodiment of the present invention, a control function “rocking free” is provided where, on determination of the driving status “vehicle stopped” after “vehicle driving forward”, the forward gear is automatically switched to the reverse gear, and with the driving status “vehicle stopped” after “vehicle reversing” a forward gear is engaged.

On the other hand, a simplified procedure provides that a control function “rocking free” is provided in which, on determination of the driving status “vehicle stopped” after an active forward motion and/or backward motion, the vehicle clutch is disengaged and on determination of the driving status “vehicle stopped” after a respective passive motion in the opposite direction, the vehicle clutch is again engaged for an active motion phase. The function “rocking free” is preferably discontinued automatically and thus ends when the vehicle has covered a predetermined distance in one direction, that is, does not stop immediately. The expression “active” indicates that there is a drive connection to the engine, whereas the expression “passive” indicates that the vehicle is rolling powerlessly.

A critical and in some situations difficult maneuver is driving in reverse. Therefore, modern vehicles offer functions that are activated especially in reverse in order to facilitate this and/or make it more uncritical. Such systems are again de-activated on subsequent forward driving.

The present invention also offers the possibility of automating these functions. Therefore, it is provided that the driving status “vehicle reversing” and/or “vehicle driving forward” is performed automatically for the adjustment of the vehicle relevant to the respective driving direction. Thus, the reverse light, a reverse drive warning signal (e.g., warning lights and/or acoustic signal), a reverse drive camera or the like could be activated in reverse. At present, engaging a reverse gear is generally the necessary condition to be detected by a related sensor. But the cases in which the vehicle is rolled backward without engaging a reverse gear are not included.

Further functions to facilitate driving in reverse could additionally be implemented, namely, adjusting the rear-view mirror for reverse driving, removing pane blinds and rocking to and fro, folding away and/or retracting parts attached to the bodywork, like spoilers and the like. Upon detection of forward driving, the vehicle could be returned automatically to a status that is appropriate for this driving direction.

In multi-axle vehicles, it can occur that on a strong steering impact, e.g., when the vehicle is driving forward, at least one wheel rotates backward. By detecting the rotational direction of the vehicle wheels this way, such a situation can easily be identified. According to a further development of the present invention, it is provided that on determination of the driving status “vehicle driving forward” and/or “vehicle reversing” and simultaneous determination of the respective operating status “at least one wheel rotating backward” and/or “at least one wheel rotating forward”, a warning signal is emitted, which calls the driver's attention to the excessively strong steering impact.

If rotational directions are detected on the wheels when the vehicle is stopped, this may suggest that the driver is changing the steer angle of the stopped vehicle. In this case it is provided that on determination of the driving status “vehicle stopped” and the operating state “at least one wheel rotating”, a warning signal is emitted. Depending on which wheel is rotating in which direction, the steering direction can be derived. If the rotational direction of one wheel changes, the amplitude of the steer angle can be derived. Excessively large steer angles can be excluded in specific operating situations, when the vehicle has to be rocked out of a pothole.

In modern automatic transmissions, it can occur that, in a transmission comprising 16 gears, the software was inadvertently programmed for a transmission with 12 gears. This may result in the vehicle starts driving in an opposite direction to the selected driving direction. This situation can be identified by way of the rotational direction detection and de-activated with adequate interventions in the control of the power train and/or brakes.

Furthermore, the parameters of the involved data array of the gearbox control can be changed automatically so that after a one-time occurrence of the situation, the correct gearbox parametrization is always active. Specifically applied, automatic hardware detection can also be implemented this way.

In a further refinement of the present invention, it is provided for a vehicle with multi-speed automatic gearbox and programmable gear control that the current rotational direction of at least one wheel or one sub-assembly in the power train is detected and compared with the respective nominal rotational direction corresponding to the engaged gear and that on lacking coinciding, a warning signal is emitted.

In modern automatic gearboxes it is not possible to switch the range change group when a vehicle has exceeded a limit speed while in reverse. This is related to the construction of the range change group synchronization. If a driver lets his vehicle roll backward and accelerates beyond a certain limit speed, the gearbox tries to shift the gear change group. This results in considerable sub-assembly stress. Such or similar situations can be prevented or de-activated by way of the rotational direction detection. The rotational direction detection can thus contribute to the protection of the sub-assemblies.

Hence, according to a further embodiment of the present invention, for a vehicle with a gearbox arranged in the power train it is provided that the current rotational direction of at least one sub-assembly of the gearbox is detected, and that on shifting, activation or deactivation procedures of the range change groups of the gearbox not corresponding to the detected rotational direction, automatic closure of the range change group shifting is carried out and/or a warning signal is emitted.

In conventional vehicles, the sub-assemblies in the powertrain of a vehicle (e.g., in the gearbox) do not have rotational direction detection. In this case, a specific rotational direction is derived on the basis of different parameters by way of a determination algorithm. The result of the calculation algorithm can be checked by way of rotational direction detection via rotation sensors. For this purpose, according to a further embodiment of the present invention, the current rotational direction of at least one sub-assembly in the powertrain can be detected and compared with the result of an algorithm for the calculation of the rotational direction.

According to a further variation of the present invention, the current rotational directions of various sub-assemblies in the power train are detected and compared to one another. The malfunction of a sensor can be determined by comparing the individual signals of several rotation sensors.

A further embodiment of the present invention provides that the current rotational direction of the gearbox output shaft is detected and compared with the nominal rotational directions at different shifting states of the gearbox. If a position sensor that should detect the position of a gearbox shifting element, that is relevant to the driving direction of the vehicle and hence the rotational direction of the gearbox output shaft fails, the rotational direction detection may show if the corresponding gear has been shifted. If the nominal specification and detected rotational direction match, it should be assumed that the shifting element has switched through. If the nominal specification and rotational direction do not match, a malfunction should be assumed.

If the position sensor, which detects the position of the gearbox shifting element relevant to the driving direction of the vehicle and hence of the gearbox output shaft, provides a valid, but wrong signal, this would be noticed on rotational direction detection in the power train because the actual rotational direction, the nominal specification and the measured position of the shifting element would not match. Thus, validation of the function of the gearbox position sensor can be achieved.

The use of rotation sensors in the power train also allows a rotational direction calculation algorithm to be completely dispensed with.

Modern rail vehicles can, in general, be equally used in both driving directions. As such rail vehicles carry a white light at the front in the direction of travel and a red light at the rear end, the lights have to be switched on inversion of the direction of travel. For this purpose, a further embodiment for such rail vehicles, according to the present invention, provides that on determination of the driving state “vehicle traveling in a first forward direction” and/or “vehicle traveling in a second forward direction”, train lights corresponding to one of the travel directions is respectively switched automatically.

A further special use of the core of the present invention is possible to refuse collection vehicles or the like with a footboard for the riding workers. In order not to put them at risk, there is a regulation stating that driving in reverse is not allowed if the footboard is occupied. This protection function against reverse driving is currently dependent on engaging the reverse gear. Rolling in reverse in such vehicles with occupied footboard could be detected and prevented by way of rotational direction detection. For this purpose, a further refinement for refuse collection vehicles or the like with a footboard for riding workers, according to the present invention, provides that on determination of the driving status “vehicle driving and/or rolling backward”, a reverse driving lock is automatically activated and/or a warning signal emitted when the footboard is occupied.

1-22. (canceled)

23. A method for controlling a driving operation of a motor vehicle in which specific driving conditions are detected by rotation sensors that are assigned to at least one of individual wheels and power train sub-assemblies, evaluated in a control unit and converted into one of control commands for specific functions of the vehicle and warning signals, the method comprising the steps of:
detecting, with the rotation sensors, a current rotational direction of at least one of a wheel and a power train sub-assembly;
evaluating the current rotational direction of at least one of the wheel and the power train sub-assembly;
determining a presence of at least one of the driving conditions comprising “driving vehicle” driving condition, “stopped vehicle” driving condition, “vehicle driving forward” driving condition, “vehicle reversing” driving condition, “wheel rotating forward” driving condition, “sub-assembly rotating forward” driving condition, “wheel rotating backward” driving condition and “sub-assembly rotating backward” driving condition; and
at least one of automatically increasing a brake pressure until reaching the “stopped vehicle” driving condition and automatically emitting a warning signal, when the “driving vehicle” driving condition and a stop condition (e.g., a certain brake pressure; accelerator not activated) are determined.

24. The method according to claim 23, further comprising the steps of detecting the current rotational direction of various driven wheels and activating a traction slip control when an “at least one rotating wheel and at least one non-rotating wheel” operating condition and a specified driving condition (e.g., gear engaged; accelerator activated) are simultaneously determined.

25. The method according to claim 23, further comprising the steps of detecting the current rotational direction of various braked wheels and activating an anti-blocking system when an “at least one rotating wheel and at least one non-rotating wheel” operating condition and a specified driving conditions (e.g., brake pedal activated) are simultaneously determined.

26. The method according to claim 23, further comprising the steps of detecting the current rotational direction of both wheels of a pair of driven wheels, and automatically connecting a differential lock when an “one rotating wheel and one non-rotating wheel” operating status and a specified driving condition (e.g., gear engaged; accelerator activated) are simultaneously determined.

27. The method according to claim 23, further comprising the steps of detecting a current rotational direction of at least one wheel of a lifting axle of a vehicle with the lifting axle, and emitting the warning signal when a “rotating wheel of the lifting axle” operating status and the “driving vehicle” driving condition and at least one of a “lifted lifting axle” driving condition and a “non-rotating wheel of the lifting axle” operating status, the “driving vehicle” driving condition and a “lowered lifting axle” driving condition are simultaneously determined.

28. The method according to claim 23, further comprising the steps of automatically activating a brake when a specific driving condition (e.g., forward gear engaged and/or reverse gear engaged) and an opposite driving condition (e.g., reversing vehicle and/or vehicle driving forward) are simultaneously determined.

29. The method according to claim 23, further comprising the steps of automatically activating a brake when a specific driving condition (e.g., vehicle driving forward and/or vehicle reversing) is determined without a determination of a corresponding driving condition (e.g., forward gear engaged and/or reverse gear engaged).

30. The method according to claim 23, further comprising the steps of providing a “rocking free” control function upon determination of the “stopped vehicle” driving condition after “vehicle driving forward”, automatic shifting from a forward gear to a reverse gear, and a “stopped vehicle” driving condition after “reversing vehicle” shifting to the forward gear is carried out.

31. The method according to claim 23, further comprising the steps of providing a “rocking free” control function, upon determination of the “stopped vehicle” driving condition after at least one of active forward motion and backward motion, a vehicle clutch is disengaged, and upon determination of the “stopped vehicle” driving condition after a passive motion in an opposite direction, again engaging the vehicle clutch.

32. The method according to claim 23, further comprising the steps of automatically adjusting the vehicle (e.g., rear-view mirror adjustment, removal of pane black-outs, reverse driving lights, reverse driving camera operation) in relation to a respective direction of travel upon on determination of at least one of the “vehicle reversing” driving condition and “vehicle driving forward” driving condition.

33. The method according to claim 23, further comprising the steps of emitting a warning signal upon determination of at least one of a driving condition “vehicle driving forward”driving condition and a “vehicle reversing” driving condition and at least one of an “at least one wheel rotating backward” operating status and “at least one wheel rotating forward”operating status in a multi-axle vehicle.

34. The method according to claim 23, further comprising the steps of emitting the warning signal upon determination of the “stopped vehicle” driving condition and the “at least one rotating wheel” operating status in a multi-axle vehicle.

35. The method according to claim 23, further comprising the steps of comparing the current rotational direction of at least one wheel and the power train sub-assembly with a respective nominal rotational direction corresponding to an engaged gear, and emitting the warning signal upon determining a lack of coincidence in a vehicle with multi-step automatic gearbox and a programmable gear control.

36. The method according to claim 23, further comprising the steps detecting one of any shifting, activation and deactivation procedure, of a range change group shifting of an automatic gearbox, not corresponding to the detected current rotational direction of the at least one power train sub-assembly of the gearbox and at least one of automatically engaging a brake and emitting the warning signal.

37. The method according to claim 23, further comprising the steps of detecting the current rotational direction of at least one sub-assembly in the power train and comparing the current rotational direction of at least one sub-assembly in the power train with a result of a calculation algorithm for a calculation of the rotational direction.

38. The method according to claim 23, further comprising the steps of detecting and comparing the current rotational directions of various sub-assemblies in the power train with one another.

39. The method according to claim 23, further comprising the steps of detecting and comparing a current rotational direction of the gearbox output shaft with nominal rotational directions at different shifting states of the gearbox.

40. The method according to claim 23 further comprising the step of illuminating a light corresponding to a respective driving direction of the vehicle with two forward driving directions opposed to one another, upon determining a driving condition “vehicle driving in a first forward direction” driving condition and a “vehicle driving in a second forward direction” driving condition.

41. The method according to claim 23 further comprising the steps of at least one of activating a reverse driving lock and emitting the warning signal, in a refuse collection vehicle with a footboard for riding workers, when at least one of a“vehicle driving backward” driving condition and “vehicle rolling backward” driving condition and the footboard is occupied.
